(19) United States
(12) Patent Application Publication
(10) Pub. No.: US 2019/0228326 A1
(43) Pub. Date: Jul. 25, 2019

(54) DEEP LEARNING DATA MANIPULATION FOR MULTI-VARIABLE DATA PROVIDERS

(71) Applicant: Intel Corporation, Santa Clara, CA (US)

(72) Inventors: Francesc Guim Bernat, Barcelona (ES); Karthik Kumar, Chandler, AZ (US)

(73) Assignee: Intel Corporation, Santa Clara, CA (US)

(21) Appl. No.: 16/367,480

(22) Filed: Mar. 28, 2019

(51) Int. Cl. G06N 5/04; G06F 16/28; G06N 20/00

(52) U.S. Cl. CPC G06N 5/04; G06N 20/00; G06F 16/28

(57) ABSTRACT

The disclosure is generally directed to systems in which numerous devices arranged to provide data are deployed. The system includes a source processing device arranged to received data from the data provider devices. The source processing data is arranged to process and/or store all or a part of the data based on whether the part of the data can be used to infer the rest of the data. The received data can be identified as either prediction data or response data. A data processing model can be used to generate inferred response data from the prediction data. Where the inferred response data is within an error threshold of the response data, then the prediction data can be stored. As such, the response data can be reproduced using the data processing model.

### BACKGROUND

Connectivity of systems are continually increasing. For example, the number of sensor devices (e.g., Internet-of-Things (IoT) devices, or the like) supplying data to cloud, edge, and other servers in expanding exponentially. As these types of deployments become more prevalent, there will be a massive increase in the number of sensors deployed, which in turn will lead to a massive increase in the volume of data produced, transmitted, and stored. Often, the edge and cloud environments with which sensor data is pushed are resource constrained in terms of network bandwidth, and storage capability. The resulting combination of increase in data coupled with resource constraints may lead to significant congestions and bottlenecks in networks as well as significant increase in resource demands in the edge and cloud environments.

### BRIEF DESCRIPTION OF THE DRAWINGS

FIG. 1 illustrates a data provider device.

FIG. 2 illustrates a source processing device.

FIG. 3 illustrates a data processing system.

FIG. 4 illustrates a technique to process data from numerous data provider devices.

FIG. 5 illustrates a source processing device.

FIG. 6 illustrates a logic flow.

FIG. 7 illustrates a logic flow.

FIG. 8 illustrates a storage medium.

FIG. 9 illustrates a computing system.

### DETAILED DESCRIPTION

Embodiments disclosed herein provide a system in which numerous sensors can be deployed, each providing data. The system includes a source processing device arranged with an inference model to infer portions of the data provided by the sensors based on other portions of the data. Accordingly, only the portion of the data needed to infer the rest (or other portion) of the data needs to be processed (e.g., aggregated, stored, manipulated, retained, or the like). In cases where the rest of the data is not inferred to within an acceptable error threshold, then all of the data may be processed.

Additionally, the inference model can be trained during operation and updated based on further training. Where the inference model is updated, a database of models can be populated and indications of which model to use to infer data from processed data can be made.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that these and similar terms are to be associated with the appropriate physical quantities and are merely convenient labels applied to those quantities.

Further, these manipulations are often referred to in terms, such as adding or comparing, which are commonly associated with logical operations. Useful machines for performing these logical operations may include general purpose digital computers as selectively activated or configured by a computer program that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

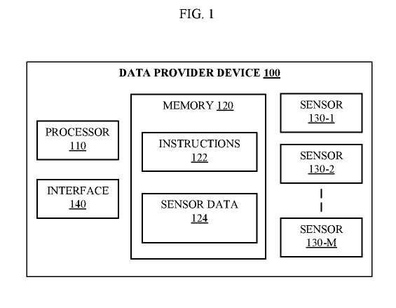

FIG. 1 illustrates a data provider device 100. The data provider device 100 is representative of any number and type of devices, arranged to record, measure, determine, or otherwise capture data. For example, data provider device 100 may be a connected sensor device, an Internet-of-Things (IoT) device, an actuator device, or the like. As shown, the data provider device 100 includes a processor 100, memory 120, a number of sensors 130, and an interface 140.

The processor 110 may include circuitry or processor logic, such as, for example, any of a variety of commercial processors. In some examples, the processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 110 may include graphics processing portions and may include dedicated memory, multiple-threaded processing and/or some other parallel processing capability. In some examples, the processor 110 may be an application specific integrated circuit (ASIC) or a field programmable integrated circuit (FPGA).

The memory 120 may include logic, a portion of which includes arrays of integrated circuits, forming non-volatile memory to persistently store data or a combination of non-volatile memory and volatile memory. It is to be appreciated, that the memory 120 may be based on any of a variety of technologies. In particular, the arrays of integrated circuits included in memory 120 may be arranged to form one or more types of memory, such as, for example, dynamic random access memory (DRAM), NAND memory, NOR memory, or the like.

The sensors 130 may be any of a variety of sensors. It is noted, data provider device 100 could include any number of sensors 130. As depicted, data provider device 100 includes sensors 130-m, where m is a positive integer; specifically, sensors 130-1, 130-2 and 130-m are depicted. Where data provider device 100 includes more than one sensor, the sensors could be similar or the same, the sensors could be different, or the sensors could be a combination of like and different sensors. In some examples, the sensors 130 could include accelerometers, magnetometers, optical sensors, cameras, microphones, thermal sensors, pressure sensors, position sensors, global positions sensors (GPS), moisture meters, force sensors, leak detectors, chemical sensors, or the like.

Interface 140 may include logic and/or features to support a communication interface. For example, the interface 140 may include one or more interfaces that operate according to various communication protocols or standards to communicate over direct or network communication links. Direct communications may occur via use of communication protocols or standards described in one or more industry standards (including progenies and variants). For example, the interface 140 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. In some examples, interface 140 may be arranged to support wireless communication protocols or standards, such as, for example, Wi-Fi, Bluetooth, ZigBee, LTE, 5G, or the like.

Memory 120 stores instructions 122 and sensor data 124. Processor 110, in executing instructions 122, can receive signals from sensors 130-m and store indications of the signals as sensor data 124. Processor 110 can repeatedly receive signals form sensors 130-m and continually store indications of such signals as sensor data 124. Thus, in some examples, sensor data 124 may be representative of multiple different instances of signals received from sensors 130-m.

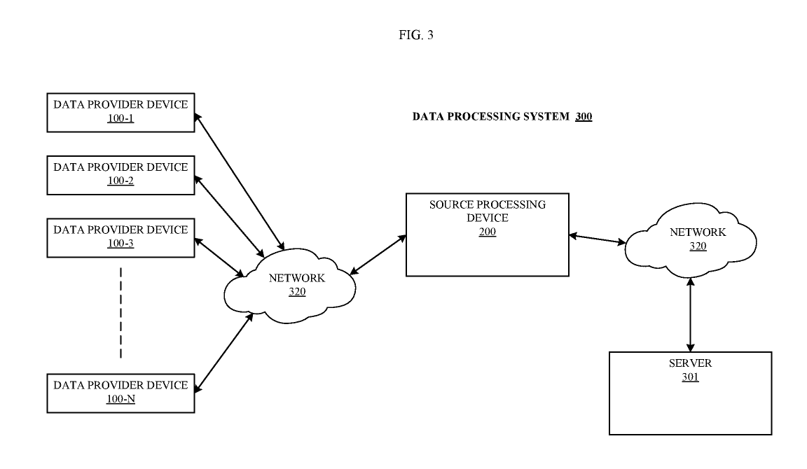

Additionally, in executing instructions 122, processor 110 can send information elements comprising indications of sensor data 124 to another computing device via interface 140. Some computing systems comprise many (e.g., hundreds, thousands, tens of thousands, etc.) data provider devices (e.g., data provider device 100), where each data provider device is arranged to capture sensor data and provide sensor data to edge or cloud computing devices. An example system including multiple data provider devise is depicted in FIG. 3. As introduced above, the present disclosure provides a system arranged to pre-process sensor data at the source or adjacent to the source, prior to offloading sensor data to the cloud or edge processing devices.

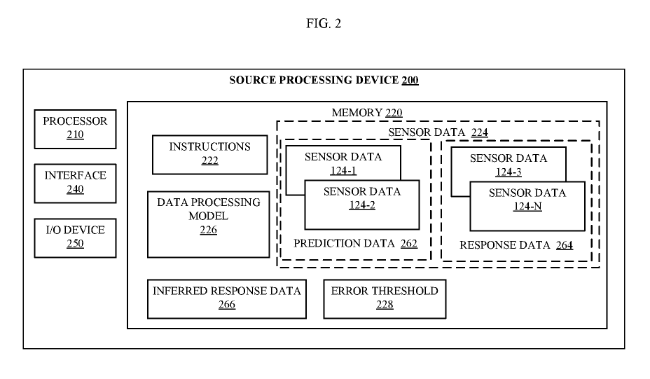

FIG. 2 illustrates a source processing device 200. The source processing device 200 is representative of any number and type of computing systems arranged to pre-process sensor data received from multiple data provider devices, like data provider device 100 of FIG. 1. Source processing device 200 can include processor 210, memory 220, interface 240, input/output (I/O) components 250.

I/O component(s) 250 may include one or more components to provide input to or to provide output from the device 200. For example, the I/O component(s) 250 may be a keyboard (hardware, virtual, etc.), mouse, joystick, microphone, track pad, button, touch layers of a display, haptic feedback device, camera, microphone, speaker, or the like.

Memory 220 stores instructions 222 and sensor data 224, data processing model 226, inferred response data 266, and error threshold 228. Processor 210, in executing instructions 222, can receive information elements from data provider devices (e.g., data provider devices 100, or the like) including indications of sensor data 224 via interface 240. Source processing device 200 could be operably coupled (e.g., wirelessly, wired, or the like) to any number of data provider devices 100. Sensor data 224 can include sensor data 124 captured by respective data provider devices coupled to source processing device 200. For example, source processing device 200 can receive sensor data 124-n, where n is a positive integer; specifically, sensor data 124-1, 124-2, 124-3 and 124-n are depicted.

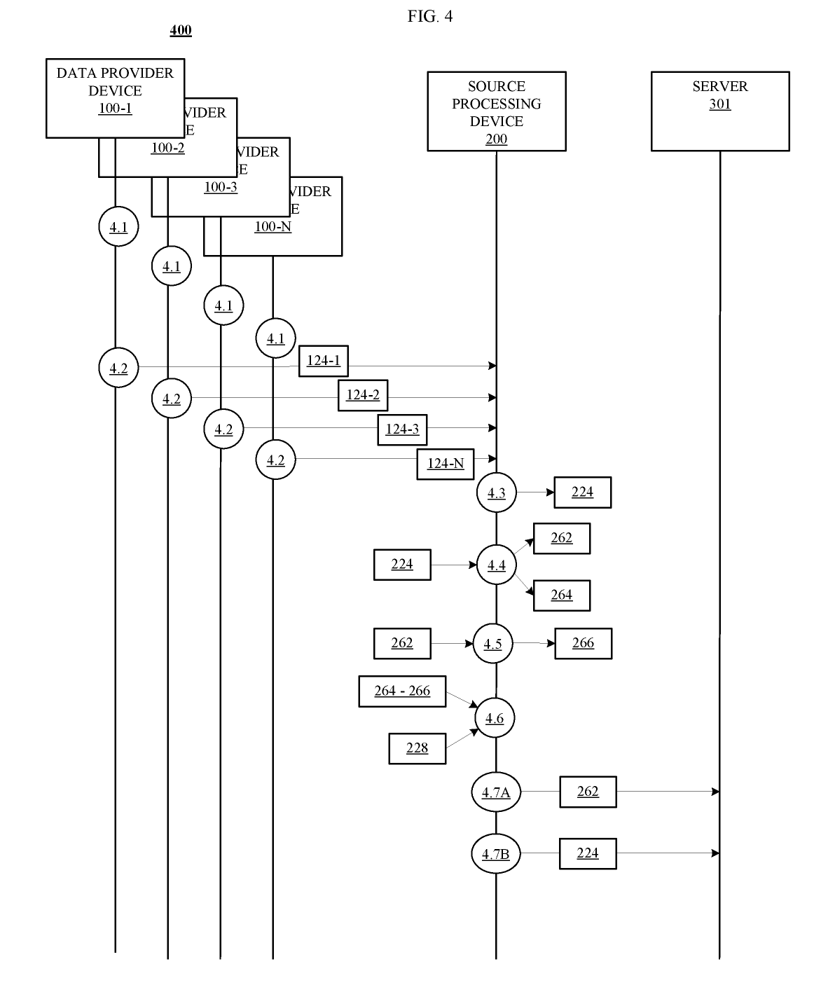

In general, sensor data 224 may be representative of multiple different instances of signals received from sensors of data provider devices coupled to source processing device 200. Accordingly, sensor data 224 can include sensor readings for a number of sensors from different devices at different instances. Processor 210, in executing instructions 224 can identify portions of sensor data 224 as prediction data 262 and other portions of sensor data 224 as response data 264. This is explained in greater detail below, for example, with reference to FIGS. 3-4. However, in some examples, sensor data 224 corresponding to sensors (e.g., sensors 130-nm) of data provider devices (e.g., data provider devices 100-n) coupled to source processing device 200 can be designated as prediction data 262 while the balance of the sensor data 224 can be designated as response data 264. Such designation can be done via metadata associated with the sensor data 224, via manual selection by a user, via preselection by a manufacturer or configurator of the system in which the devices are deployed, or the like.

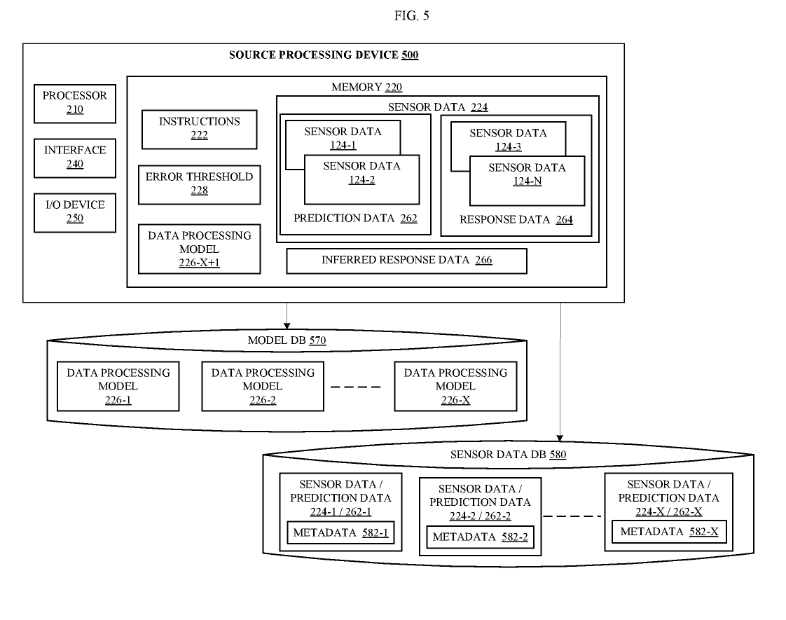

Processor 210, in executing instructions 224, can execute data processing model 226 to generate inferred response data 266 from prediction data 262. In some examples, data processing model 226 can be a deep learning model, such as, a deep neural network (DNN), or the like. In general, data processing model 226 can be trained to infer response data 264 from prediction data 262. Examples of this are described in greater detail below, for example, with reference to FIG. 5.

Processor 210, in executing instructions 224, can determine an error between inferred response data 266 and response data 264 and compare (e.g., less than, less than or equal to, greater than, greater than or equal to, etc.) the determined error with the error threshold 228. Based on the comparison, processor 210, in executing instructions can send information elements comprising indications of sensor data 224 or just prediction data 262 to another computing device (e.g., an edge device, a cloud device, a local storage device, or the like) via interface 240. For example, where the error between the inferred response data 266 and the response data 264 is less than the error threshold 228, then source processing device 200 can record (e.g., store locally, send to another computing device, or the like) only the prediction data 262 as the prediction data 262 can be used, in conjunction with data processing model 226, to recreate the response data 264 within an acceptable error rate (e.g., inferred response data 266, or the like).

FIG. 3 illustrates a data processing system 300. The data processing system 300 is representative of a system where multiple data provider devices are deployed. Such a system could be deployed in any of a variety of environments, such as, residential, commercial, industrial, or the like. Data processing system 300 can include a number of data provider devices 100, a source processing device 200, and a server 301. The server 301 can be representative of any of a variety of cloud, edge, or network attached processing devices arranged to consume data generated by data provider devices 100.

Although in many systems like system 300, large numbers (e.g., hundreds, thousands, tens of thousands, etc.) of data provider devices 100 may be deployed; a limited number of data provider devices 100 are depicted in this figure for purposes of clarity. For example, data processing system 300 is depicted including data provider devices 100-1, 100-2, 100-3, and 100-N, where N is a positive integer. Each of data provider devices 100 are coupled to source processing device 200 via network 310. Source processing device 200 is in turn coupled to server 301 via network 320. In some examples, networks 310 and/or 320 can be a local area network, a mesh network, an ad-hoc network, the Internet, or the like. As a specific example, network 310 can be a mesh network while network 320 comprises the Internet.

FIG. 4 illustrates technique 400, which can be representative of operations performed in operation of data processing system 300. Technique 400 is described with reference to the system 300 and devices 200 and 100 of FIGS. 1-3. Technique 400 can begin at circles 4.1. At circles 4.1, data provider devices 100 (e.g., devices deployed in system 300, or the like) can capture sensor data 124. For example, processor 110, in executing instructions 122 can receive signals from sensors 130 and store indications of the signals as sensor data 124. It is noted, that each of the data provider devices 100 (e.g., data provider devices 100-1, 100-2, 100-3 and 100-N) can capture respective sensor data 124 at circles 4.1. In some instances, data provider devices 100 can repeatedly carry out circle 4.1 to repeatedly capture sensor data 124.

Continuing to circle 4.2, data provider devices 100 (e.g., devices deployed in system 300, or the like) can send indications (e.g., information elements, or the like) of respective sensor data 124 to source processing device 200. For example, processor 110, in executing instructions 122 can send an information element including indications of sensor data 124 to source processing device 200 via interface 140. It is noted, that each of the data provider devices 100 (e.g., data provider devices 100-1, 100-2, 100-3 and 100-N) can send respective sensor data 124 at circles 4.2. In some instances, data provider devices 100 can repeatedly carry out circle 4.2 to repeatedly send sensor data 124 to source processing device 200.

With some examples, each of data provider devices 100 can execute operations associated with circles 4.1 and 4.2 at different time intervals. For example, data provider device 100-1 need not execute circles 4.1 and/or 4.2 at the same instance that data provider device 100-2 executes circles 4.1 and/or 4.2.

Continuing to circle 4.3, source processing device 200 can receive sensor data 224, including indications of sensor data 124 associated with each data provider device. For example, processor 210, in executing instructions 222 can store sensor data 224 including indications of sensor data 124 (e.g., sensor data 124-1, 124-2, 124-3 and 124-N) received from data provider devices 100. Continuing to circle 4.4, source processing device 200 can identify prediction data 262 and response data 264 from sensor data 224. For example, processor 210, in executing instructions 222, can identify (e.g., based on metadata associated with sensor data 124, based on sensors 130 associated with sensor data 124, or the like) portions of sensor data 224 that are classified as prediction data 262 and portions of sensor data 224 that are classified as response data 264.

Continuing to circle 4.5, source processing device 200 can generate inferred response data 266 based on prediction data 262. For example, processor 210, in executing instructions 222 can generate inferred response data 266 based on executing data processing model 226 with prediction data 262 as inputs. Continuing to block 4.6, source processing device 200 can compare an error between inferred response data 266 and response data 264 to error threshold 228. For example, processor 210, in executing instructions 222 can determine a difference between inferred response data 266 and response data 264 and compare the determined difference with error threshold 228.

From circle 4.6, technique 400 can continue to either circle 4.7A or circle 4.7B based on the comparison of the difference between inferred response data 266 and response data 264 with error threshold 228. Technique 400 can continue from circle 4.6 to circle 4.7A based on a determination that a difference between the inferred response data 266 and response data 264 is less than (less than or equal to, or the like) error threshold 228. Alternatively, technique 400 can continue from circle 4.6 to circle 4.7B based on a determination that a difference between the inferred response data 266 and response data 264 is greater than (greater than or equal to, or the like) error threshold 228.

At circle 4.7A, source processing device 200 can offload prediction data 262. For example, processor 210, in executing instructions 222 can send an information element including indications of prediction data 262 to server 301 via interface 240. As another example, processor 210, in executing instructions 222 can store indications of prediction data 262 to long term storage (e.g., on server 301, cloud storage, edge attached storage, or the like).

At circle 4.7B, source processing device 200 can offload sensor data 224. For example, processor 210, in executing instructions 222 can send an information element including indications of sensor data 224 to server 301 via interface 240. As another example, processor 210, in executing instructions 222 can store indications of sensor data 224 to long term storage (e.g., on server 301, cloud storage, edge attached storage, or the like).

With some examples, source processing device (e.g., source processing device 200, or the like) can be arranged to train and update data processing model 226 during operation. FIG. 5 illustrates source processing device 200 coupled to a model database (db) 570 and a sensor data database 580. In general, model db 570 and sensor data db 580 can be implemented in local storage to source processing device 200, implemented in server 301, or implemented in some other cloud or edge attached storage device. Examples are not limited in this context.

During operation, source processing device 200 can receive sensor data 224 and can offload either sensor data 224 or prediction data 262 are described herein. Furthermore, source processing device 200 can train data processing model 226. For example, as described herein, data processing model 226 can be a DNN. DNN's can be trained using an iterative process where weights and/or connections within the DNN are modified and updated based on feedback of how well the model infers the expected output. As a specific example, data processing model 226 could be trained with sensor data 224 (e.g., prediction data 262 and response data 264) as the training data. More particularly, processing 210 in executing instructions 222, can train (e.g., using DNN training techniques such as, for example, backpropagation or the like) and repeatedly update the data processing model 226.

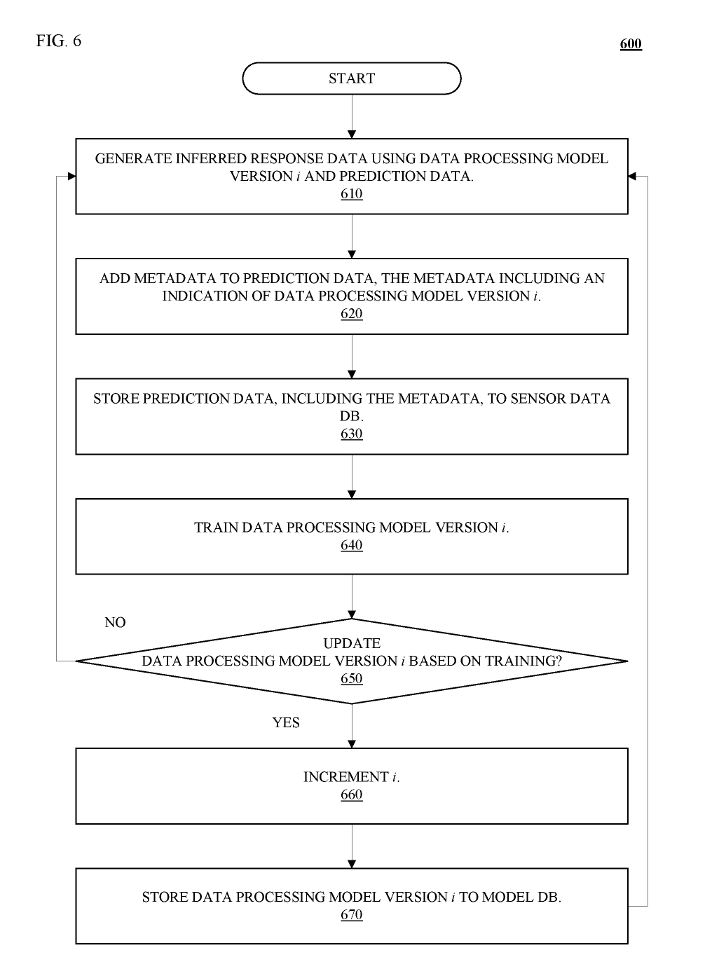

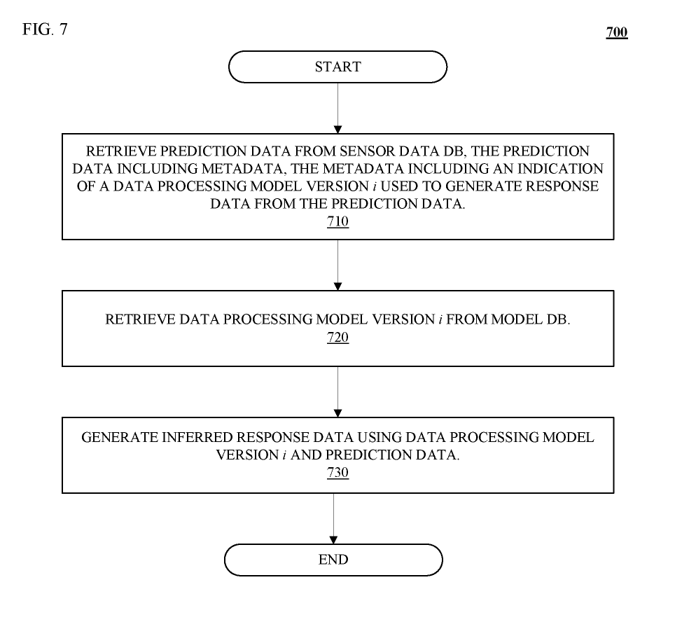

Processor 210, in executing instructions 222, can store instances of data processing models 226 to model db 270. For example, at each instance where data processing model 226 is updated (e.g., based on training, or the like), processor 210 can store a copy of the updated model to model db 270. Thus, model db 270 can include a number of instances or version of data processing model 262. This figure depicts data processing model versions 226-1, 226-2 and 226-X. Furthermore, during operation, processor 210 in executing instructions 222 can store indications of which data processing model 226 (e.g., which model version, or the like) was used to generate stored prediction data 262 in metadata 582. As depicted, data (e.g., sensor data 224, prediction data 262, etc.) stored in sensor data db 580 includes metadata 582. The metadata 582 includes indications of which version of data processing model 226 is to be used to recreate response data 264. Thus, response data 264 can be recreated using the appropriate model 226. This is described in greater detail below, for example, with respect to FIGS. 6-7.

As discussed, in some implementations model db 570 may be stored locally to source processing device 200 while in other implementations model db 570 is remotely located (e.g., on a cloud storage device, on an edge storage device, or the like). In some examples, model db 570 may be limited in size such that only a select number of versions of data processing model 226 can be stored in model db 570. Accordingly, within some examples, once a select number of data processing models 226 are stored in model db 570; a data processing model 226 currently stored in model db 570 can be removed each time a new data processing model 226 is stored in model db 570. As a specific example, the oldest data processing model 226 (e.g., earlier version number, or the like) can be removed. As another example, the data processing model 226 stored in model db 570 with the highest error rate can be removed.

When a version of data processing model 226 is removed from model db 570, any metadata 582 referencing that version of data processing model 226 can be updated to indicate another (e.g., next recent version, or the like) version of data processing model 226. Alternatively, where prediction data 262 is stored that references a version of data processing model 226 that is being removed, response data 264 can be generated from prediction data 262 and the data processing model 226 before the model is removed from the model db. The generated response data 264 can then be stored to sensor data db 580.

FIG. 6 illustrates a logic flow 600. The logic flow 600 may be representative of some or all the operations executed by one or more embodiments described herein. For example, source processing device 200 (or components thereof) may perform the operations in logic flow 600 to offload sensor data and train the data processing model. Logic flow 600 may begin at block 610 “generate inferred response data using data processing model version i and prediction data” where inferred response data can be generated from a data processing model and prediction data. For example, inferred response data 266 can be generated from a data processing model 226 (e.g., version i, where i is a positive integer) and prediction data 262.

Continuing to block 620 “add metadata to prediction data, the metadata including an indication of data processing model version i” metadata including an indication of the data processing model version used to generated inferred response data can be added to the prediction data. For example, metadata including an indication of the version of data processing model 226 (e.g., data processing model version 226-1, 226-2, 226-X, or the like) used to generate inferred response data 266 from prediction data 262 can be added to prediction data 262.

Continuing to block 630 “store prediction data, including the metadata, to sensor data db” prediction data including the metadata added at block 620 can be stored to a sensor data db. For example, prediction data 262 including metadata indicating the version of data processing model 226 used with the prediction data 262 can be stored to sensor data db 580.

Continuing to block 640 “train data processing model version i” the data processing model (e.g., version i, the current version, or the like) can be trained. For example, data processing model 226 (e.g., version 226-1, 226-2, 226-X, or the like) can be trained based in part on training data comprising prediction data 262 and response data 264.

Continuing to decision block 650 “update data processing model version i based on training?” a determination of whether to update the data processing model based on recent training can be made. In some examples, the data processing model 226 can be updated to a new version (e.g., further trained model can replace existing model, or the like) repeatedly. As a specific example, the data processing model 226 can be updated to a new version on specified intervals (e.g., hourly, daily, weekly, etc.). Based on a determination that the data processing model 226 is not to be updated, logic flow 600 can return to block 610. Based on a determination that data processing model 226 is to be updated, logic flow 600 can continue to block 660.

At block 660 “increment i” the data processing model version number “i” can be incremented. Continuing to block 670 “store data processing model version i to model db” the data processing model version i can be stored to a model db. For example, the newly updated version (e.g., version 226-2, 226-X, or the like) of data processing model 226 can be stored to model db 270. From block 670, logic flow 600 can return to block 610.

FIG. 7 illustrates an embodiment of a logic flow 700. The logic flow 700 may be representative of some or all the operations executed by one or more embodiments described herein. For example, source processing device 200 (or components thereof) or server 301 (or components thereof) may perform the operations in logic flow 700 to recreate or retrieve response data from saved prediction data.

Logic flow 700 may begin at block 710 “retrieve prediction data from sensor data db, the prediction data including metadata, the metadata including an indication of a data processing model version i used to generate response data from the prediction data” prediction data can be retrieved from sensor data db. For example, prediction data 262 including metadata indicating the version of data processing model 226 used with the prediction data 262 can be retrieved from sensor data db 580.

Continuing to block 720 “retrieve data processing model version i from model db” data processing model version i can be retrieved from model db. For example, the version i (e.g., version 226-1, 226-2, 226-X, or the like) of data processing model 226 indicated in metadata of prediction data 262, can be retrieved from model db 570. Continuing to block 730 “generate inferred response data using data processing model version i and prediction data” inferred response data ban be generated. For example, inferred response data 266 can be generated from the retrieved data processing model 226 and the retrieved prediction data 262 to recreate response data 264.

In some examples, model db 570 can be used similar to a “cache” to store data processing models 226. For example, data processing models 226 can be stored in model db 570 are described above. During operations where source processing device 200 is to recreate response data 264, the currently data processing model 226 stored at source processing device 200 can be evicted to (e.g., stored to) model db 570 as described herein and the data processing model 226 to be used for inferencing can be retrieved from model db 570 as described herein and stored at source processing device 200.

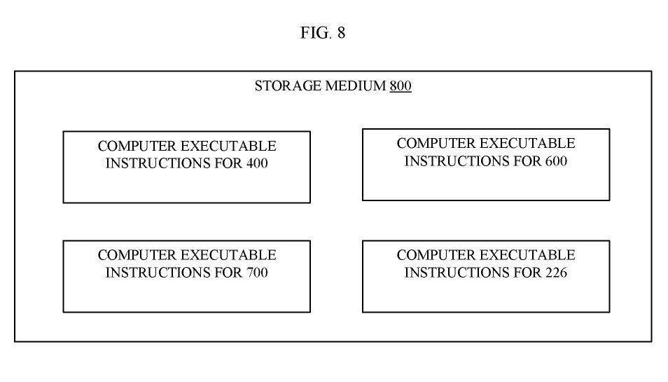

FIG. 8 illustrates an embodiment of a storage medium 800. Storage medium 800 may comprise any non-transitory computer-readable storage medium or machine-readable storage medium, such as an optical, magnetic or semiconductor storage medium. In various embodiments, storage medium 800 may comprise an article of manufacture. In some embodiments, storage medium 800 may store computer-executable instructions, such as computer-executable instructions to implement one or more of techniques, logic flows, or operations described herein, such as with respect to 400, 600, and/or 700 of FIGS. 4 and 6-7. The storage medium 800 may further store computer-executable instructions for the data processing model 226. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

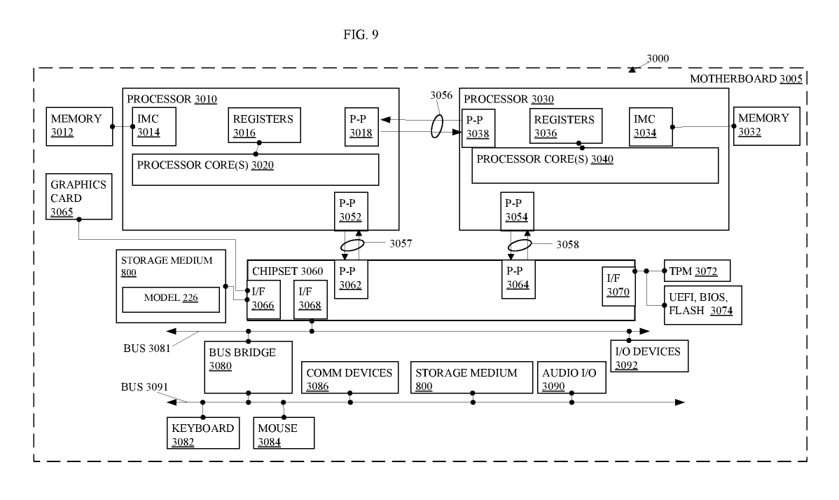

FIG. 9 illustrates an embodiment of a system 3000. The system 3000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 3000 may have a single processor with one core or more than one processor. Note that the term “processor” refers to a processor with a single core or a processor package with multiple processor cores. In at least one embodiment, the computing system 3000 is representative of the source processing device 200. More generally, the computing system 3000 is configured to implement all logic, systems, logic flows, methods, apparatuses, and functionality described herein with reference to FIGS. 1-8.

Any functionality described in this application is intended to refer to a structure (e.g., circuitry, or the like) of a computer-related entity arranged to implement the described functionality. Structural examples of such a computer-related entity are provided by the exemplary system 3000. For example, such structure can be, but is not limited to, a processor, a processor executing a process, a hard disk drive, multiple storage drives (of optical and/or magnetic storage medium), a thread of execution, a program, and/or a computer. Further, the structure(s) may be communicatively coupled to each other by various types of communications media to coordinate operations. The coordination may involve the uni-directional or bi-directional exchange of information. For instance, the structure may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 3000 comprises a motherboard 3005 for mounting platform components. The motherboard 3005 is a point-to-point interconnect platform that includes a first processor 3010 and a second processor 3030 coupled via a point-to-point interconnect 3056 such as an Ultra Path Interconnect (UPI). In other embodiments, the system 3000 may be of another bus architecture, such as a multi-drop bus. Furthermore, each of processors 3010 and 3030 may be processor packages with multiple processor cores including processor core(s) 3020 and 3040, respectively. While the system 3000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 3010 and the chipset 3060. Some platforms may include additional components and some platforms may only include sockets to mount the processors and/or the chipset.

The processors 3010, 3020 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi processor architectures may also be employed as the processors 3010, 3020.

The first processor 3010 includes an integrated memory controller (IMC) 3014 and point-to-point (P-P) interfaces 3018 and 3052. Similarly, the second processor 3030 includes an IMC 3034 and P-P interfaces 3038 and 3054. The IMC's 3014 and 3034 couple the processors 3010 and 3030, respectively, to respective memories, a memory 3012 and a memory 3032. The memories 3012 and 3032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 3012 and 3032 locally attach to the respective processors 3010 and 3030. In other embodiments, the main memory may couple with the processors via a bus and shared memory hub.

The processors 3010 and 3030 comprise caches coupled with each of the processor core(s) 3020 and 3040, respectively. In the present embodiment, the processor core(s) 3020 of the processor 3010 and the processor core(s) 3040 of processor 3030 include the neural network logic 101, convolution algorithm logic 102, non-zero weight recovery logic 103, and weight value from weight ID logic 104. The processor cores 3020, 3040 may further include memory management logic circuitry (not pictured) which may represent circuitry configured to implement the functionality of technique 400, logic flow 600, logic flow 700, and/or data processing model 226 in the processor core(s) 3020, 3040, or may represent a combination of the circuitry within a processor and a medium to store all or part of data processing model 226 in memory such as cache, the memory 3012, buffers, registers, and/or the like. The functionality of technique 400, logic flow 600, logic flow 700, and/or data processing model 226 may reside in whole or in part as code in a memory such as the storage medium 800 attached to the processors 3010 and/or 3030 via a chipset 3060. The functionality of technique 400, logic flow 600, logic flow 700, and/or data processing model 226 may also reside in whole or in part in memory such as the memory 3012 and/or a cache of the processor. Furthermore, the functionality of technique 400, logic flow 600, logic flow 700, and/or data processing model 226 may also reside in whole or in part as circuitry within the processor 3010 and may perform operations, e.g., within registers or buffers such as the registers 3016 within the processors 3010, 3030, or within an instruction pipeline of the processors 3010, 3030. Further still, the functionality of technique 400, logic flow 600, logic flow 700, and/or data processing model 226 may be integrated a processor of the hardware accelerator for performing inference using a DNN.

As stated, more than one of the processors 3010 and 3030 may comprise the functionality of technique 400, logic flow 600, logic flow 700, and/or data processing model 226, such as the processor 3030 and/or a processor within the hardware accelerator 106 coupled with the chipset 3060 via an interface (I/F) 3066. The I/F 3066 may be, for example, a Peripheral Component Interconnect-enhanced (PCI-e).

The first processor 3010 couples to a chipset 3060 via P-P interconnects 3052 and 3062 and the second processor 3030 couples to a chipset 3060 via P-P interconnects 3054 and 3064. Direct Media Interfaces (DMIs) 3057 and 3058 may couple the P-P interconnects 3052 and 3062 and the P-P interconnects 3054 and 3064, respectively. The DMI may be a high-speed interconnect that facilitates, e.g., eight Giga Transfers per second (GT/s) such as DMI 3.0. In other embodiments, the processors 3010 and 3030 may interconnect via a bus.

The chipset 3060 may comprise a controller hub such as a platform controller hub (PCH). The chipset 3060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 3060 may comprise more than one controller hub such as a chipset with a memory controller hub, a graphics controller hub, and an input/output (I/O) controller hub.

In the present embodiment, the chipset 3060 couples with a trusted platform module (TPM) 3072 and the UEFI, BIOS, Flash component 3074 via an interface (I/F) 3070. The TPM 3072 is a dedicated microcontroller designed to secure hardware by integrating cryptographic keys into devices. The UEFI, BIOS, Flash component 3074 may provide pre-boot code.

Furthermore, chipset 3060 includes an I/F 3066 to couple chipset 3060 with a high-performance graphics engine, graphics card 3065. In other embodiments, the system 3000 may include a flexible display interface (FDI) between the processors 3010 and 3030 and the chipset 3060. The FDI interconnects a graphics processor core in a processor with the chipset 3060.

Various I/O devices 3092 couple to the bus 3081, along with a bus bridge 3080 which couples the bus 3081 to a second bus 3091 and an I/F 3068 that connects the bus 3081 with the chipset 3060. In one embodiment, the second bus 3091 may be a low pin count (LPC) bus. Various devices may couple to the second bus 3091 including, for example, a keyboard 3082, a mouse 3084, communication devices 3086 and the storage medium 700 that may store computer executable code as previously described herein. Furthermore, an audio I/O 3090 may couple to second bus 3091. Many of the I/O devices 3092, communication devices 3086, and the storage medium 800 may reside on the motherboard 3005 while the keyboard 3082 and the mouse 3084 may be add-on peripherals. In other embodiments, some or all the I/O devices 3092, communication devices 3086, and the storage medium 800 are add-on peripherals and do not reside on the motherboard 3005.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The following examples pertain to further embodiments, from which numerous permutations and configurations will be apparent.

Example 1. An apparatus, comprising: a processor; and a memory storing instructions, which when executed by the processor cause the processor to: receive data from a plurality of data provider devices; identify a first portion of the received data as prediction data; identify a second portion, different than the first portion, of the received data as response data; generate inferred response data based in part on a data processing model and the prediction data; and store either the prediction data or the received data to a memory storage location based in part on a comparison between the inferred response data, the response data, and an error threshold.

Example 2. The apparatus of example 1, the memory storing instructions, which when executed by the processor cause the processor to execute the data processing model with the prediction data as input to generate the inferred response data.

Example 3. The apparatus of examples 1 or 2, each of the plurality of data provider devices comprising at least one sensor, the received data comprising indications of signals received from the at least one sensor of the plurality of data provider devices, the memory storing instructions, which when executed by the processor cause the processor to: identify the first portion of the received data based in part on the at least one sensor of the plurality of data provider devices associated with the first portion of the received data; and identify the second portion of the received data based in part on the at least one sensor of the plurality of data provider devices associated with the second portion of the received data, wherein the at least one sensor of the plurality of data provider devices associated with the first portion of the received data are different from the at least one sensor of the plurality of data provider devices associated with the second portion of the received data.

Example 4. The apparatus of examples 1, 2, or 3, the memory storing instructions, which when executed by the processor cause the processor to train the data processing model based in part on the received data, to generate a further trained data processing model.

Example 5. The apparatus of example 4, the memory storing instructions, which when executed by the processor cause the processor to: update a version of the data processing model based on the further trained data processing model; store the updated version of the data processing model to a model database; receive additional data from the plurality of data provider devices; identify a first portion of the received additional data as additional prediction data; identify a second portion, different than the first portion, of the received additional data as additional response data; generate additional inferred response data based in part on the updated version of the data processing model and the additional prediction data; add metadata to the received additional data including an indication of the updated version of the data processing model; and store either the additional prediction data or the received additional data to the memory storage location based in part on a comparison between the inferred additional response data, the additional response data, and the error threshold.

Example 6. The apparatus of examples 1, 2, 3, 4, or 5 the memory storing instructions, which when executed by the processor cause the processor to: determine a difference between the response data and the inferred response data; determine whether the difference is less than, or less than or equal to the error threshold; and store the prediction data to the memory storage location based on a determination that the difference is less than, or less than or equal to the error threshold.

Example 7. The apparatus of example 6, the memory storing instructions, which when executed by the processor cause the processor to store the received data to the memory storage location based on a determination that the difference is not less than, or not less than or equal to the error threshold.

Example 8. The apparatus of examples 1, 2, 3, 4, 5, 6, or 7, the memory storing instructions, which when executed by the processor cause the processor to send an information element comprising indications of either the prediction data or the received data to a cloud computing device or an edge computing device, wherein the cloud computing device or the edge computing device is to store the prediction data or the received data to the memory storage location.

Example 9. The apparatus of examples 1, 2, 3, 4, 5, 6, 7, or 8, the memory storing instructions, which when executed by the processor cause the processor to: retrieve the prediction data from the memory storage location; and generate the inferred response data based in part on the prediction data and the data processing model to retrieve the response data.

Example 10. A non-transitory computer-readable storage medium, comprising instructions that when executed by a computing device, cause the computing device to: receive data from a plurality of data provider devices; identify a first portion of the received data as prediction data; identify a second portion, different than the first portion, of the received data as response data; generate inferred response data based in part on a data processing model and the prediction data; store either the prediction data or the received data to a memory storage location based in part on a comparison between the inferred response data, the response data, and an error threshold.

Example 11. The non-transitory computer-readable storage medium of example 10, comprising instructions that when executed by the computing device, cause the computing device to execute the data processing model with the prediction data as input to generate the inferred response data.

Example 12. The non-transitory computer-readable storage medium of examples 10 or 11, each of the plurality of data provider devices comprising at least one sensor, the received data comprising indications of signals received from the at least one sensor of the plurality of data provider devices, the medium comprising instructions that when executed by the computing device, cause the computing device to: identify the first portion of the received data based in part on the at least one sensor of the plurality of data provider devices associated with the first portion of the received data; and identify the second portion of the received data based in part on the at least one sensor of the plurality of data provider devices associated with the second portion of the received data, wherein the at least one sensor of the plurality of data provider devices associated with the first portion of the received data are different from the at least one sensor of the plurality of data provider devices associated with the second portion of the received data.

Example 13. The non-transitory computer-readable storage medium of examples 10, 11, or 12, comprising instructions that when executed by the computing device, cause the computing device to train the data processing model based in part on the received data, to generate a further trained data processing model.

Example 14. The non-transitory computer-readable storage medium of example 13, comprising instructions that when executed by the computing device, cause the computing device to: update a version of the data processing model based on the further trained data processing model; store the updated version of the data processing model to a model database; receive additional data from the plurality of data provider devices; identify a first portion of the received additional data as additional prediction data; identify a second portion, different than the first portion, of the received additional data as additional response data; generate additional inferred response data based in part on the updated version of the data processing model and the additional prediction data; add metadata to the received additional data including an indication of the updated version of the data processing model; and store either the additional prediction data or the received additional data to the memory storage location based in part on a comparison between the inferred additional response data, the additional response data, and the error threshold.

Example 15. The non-transitory computer-readable storage medium of examples 10, 11, 12, 13, or 14, comprising instructions that when executed by the computing device, cause the computing device to: determine a difference between the response data and the inferred response data; determine whether the difference is less than, or less than or equal to the error threshold; and store the prediction data to the memory storage location based on a determination that the difference is less than, or less than or equal to the error threshold.

Example 16. The non-transitory computer-readable storage medium of example 15, comprising instructions that when executed by the computing device, cause the computing device to store the received data to the memory storage location based on a determination that the difference is not less than, or not less than or equal to the error threshold.

Example 17. The non-transitory computer-readable storage medium of examples 10, 11, 12, 13, 14, 15, or 16, comprising instructions that when executed by the computing device, cause the computing device to send an information element comprising indications of either the prediction data or the received data to a cloud computing device or an edge computing device, wherein the cloud computing device or the edge computing device is to store the prediction data or the received data to the memory storage location.

Example 18. The non-transitory computer-readable storage medium of examples 10, 11, 12, 13, 14, 15, 16, or 17, comprising instructions that when executed by the computing device, cause the computing device to: retrieve the prediction data from the memory storage location; generate the inferred response data based in part on the prediction data and the data processing model to retrieve the response data.

Example 19. A system comprising: a plurality of data provider devices, each of the plurality of data provider devices comprising: at least one sensor; an interface; and circuitry coupled to the at least one sensor and the interface, the circuitry to: receive signals from the at least one sensor; and send, via the interface, indications of the signals to a source processing device; and the source processing device, comprising: a processor; and memory storing instructions, which when executed by the processor cause the processor to: receive data from the plurality of data provider devices, the data comprising indications of the signals received from the at least one sensor of the plurality of data service providers; identify a first portion of the received data as prediction data; identify a second portion, different than the first portion, of the received data as response data; generate inferred response data based in part on a data processing model and the prediction data; and store either the prediction data or the received data to a memory storage location based in part on a comparison between the inferred response data, the response data, and an error threshold.

Example 20. The system of example 19, the memory storing instructions, which when executed by the processor cause the processor to execute the data processing model with the prediction data as input to generate the inferred response data.

Example 21. The system of examples 19 or 20, the memory storing instructions, which when executed by the processor cause the processor to: identify the first portion of the received data based in part on the at least one sensor of the plurality of data provider devices associated with the first portion of the received data; and identify the second portion of the received data based in part on the at least one sensor of the plurality of data provider devices associated with the second portion of the received data, wherein the at least one sensor of the plurality of data provider devices associated with the first portion of the received data are different from the at least one sensor of the plurality of data provider devices associated with the second portion of the received data.

Example 22. The system of examples 19, 20, or 21, the memory storing instructions, which when executed by the processor cause the processor to: train the data processing model based in part on the received data, to generate a further trained data processing model; update a version of the data processing model based on the further trained data processing model; store the updated version of the data processing model to a model database; receive additional data from the plurality of data provider devices; identify a first portion of the received additional data as additional prediction data; identify a second portion, different than the first portion, of the received additional data as additional response data; generate additional inferred response data based in part on the updated version of the data processing model and the additional prediction data; add metadata to the received additional data including an indication of the updated version of the data processing model; and store either the additional prediction data or the received additional data to the memory storage location based in part on a comparison between the inferred additional response data, the additional response data, and the error threshold.

Example 23. The system of examples 19, 20, 21, or 22, the memory storing instructions, which when executed by the processor cause the processor to: determine a difference between the response data and the inferred response data; determine whether the difference is less than, or less than or equal to the error threshold; and store the prediction data to the memory storage location based on a determination that the difference is less than, or less than or equal to the error threshold; or store the received data to the memory storage location based on a determination that the difference is not less than, or not less than or equal to the error threshold.

Example 24. The system of examples 19, 20, 21, 22, or 23, the memory storing instructions, which when executed by the processor cause the processor to send an information element comprising indications of either the prediction data or the received data to a cloud computing device or an edge computing device, wherein the cloud computing device or the edge computing device is to store the prediction data or the received data to the memory storage location.

Example 25. The system of examples 19, 20, 21, 22, 23, or 24, the memory storing instructions, which when executed by the processor cause the processor to: retrieve the prediction data from the memory storage location; generate the inferred response data based in part on the prediction data and the data processing model to retrieve the response data.

Example 26. A method, comprising: receiving data from a plurality of data provider devices; identifying a first portion of the received data as prediction data; identifying a second portion, different than the first portion, of the received data as response data; generating inferred response data based in part on a data processing model and the prediction data; storing either the prediction data or the received data to a memory storage location based in part on a comparison between the inferred response data, the response data, and an error threshold.

Example 27. The method of example 26, comprising executing the data processing model with the prediction data as input to generate the inferred response data.

Example 28. The method of example 27, each of the plurality of data provider devices comprising at least one sensor, the received data comprising indications of signals received from the at least one sensor of the plurality of data provider devices, the method comprising: identifying the first portion of the received data based in part on the at least one sensor of the plurality of data provider devices associated with the first portion of the received data; and identifying the second portion of the received data based in part on the at least one sensor of the plurality of data provider devices associated with the second portion of the received data, wherein the at least one sensor of the plurality of data provider devices associated with the first portion of the received data are different from the at least one sensor of the plurality of data provider devices associated with the second portion of the received data.

Example 29. The method of examples 26, 27, or 28, comprising training the data processing model based in part on the received data, to generate a further trained data processing model.

Example 30. The method of example 29, comprising: updating a version of the data processing model based on the further trained data processing model; storing the updated version of the data processing model to a model database; receiving additional data from the plurality of data provider devices; identifying a first portion of the received additional data as additional prediction data; identify a second portion, different than the first portion, of the received additional data as additional response data; generating additional inferred response data based in part on the updated version of the data processing model and the additional prediction data; adding metadata to the received additional data including an indication of the updated version of the data processing model; and storing either the additional prediction data or the received additional data to the memory storage location based in part on a comparison between the inferred additional response data, the additional response data, and the error threshold.

Example 31. The method of examples 26, 27, 28, 29, or 30, comprising: determining a difference between the response data and the inferred response data; determining whether the difference is less than, or less than or equal to the error threshold; and storing the prediction data to the memory storage location based on a determination that the difference is less than, or less than or equal to the error threshold.

Example 32. The method of example 31, comprising storing the received data to the memory storage location based on a determination that the difference is not less than, or not less than or equal to the error threshold.

Example 33. The method of examples 26, 27, 28, 29, 30, or 31, comprising sending an information element comprising indications of either the prediction data or the received data to a cloud computing device or an edge computing device, wherein the cloud computing device or the edge computing device is to store the prediction data or the received data to the memory storage location.

Example 34. The method of examples 26, 27, 28, 29, 30, 31, 32, or 33, comprising: retrieving the prediction data from the memory storage location; and generating the inferred response data based in part on the prediction data and the data processing model to retrieve the response data.

Example 35. An apparatus, comprising means arranged to implement the function of any one of examples 26 to 34.

What is claimed is:

1. An apparatus, comprising:
a processor; and
a memory storing instructions, which when executed by the processor cause the processor to:
receive data from a plurality of data provider devices;
identify a first portion of the received data as prediction data;
identify a second portion, different than the first portion, of the received data as response data;
generate inferred response data based in part on a data processing model and the prediction data; and
store either the prediction data or the received data to a memory storage location based in part on a comparison between the inferred response data, the response data, and an error threshold.

2. The apparatus of claim 1, the memory storing instructions, which when executed by the processor cause the processor to execute the data processing model with the prediction data as input to generate the inferred response data.

3. The apparatus of claim 1, each of the plurality of data provider devices comprising at least one sensor, the received data comprising indications of signals received from the at least one sensor of the plurality of data provider devices, the memory storing instructions, which when executed by the processor cause the processor to:
identify the first portion of the received data based in part on the at least one sensor of the plurality of data provider devices associated with the first portion of the received data; and
identify the second portion of the received data based in part on the at least one sensor of the plurality of data provider devices associated with the second portion of the received data, wherein the at least one sensor of the plurality of data provider devices associated with the first portion of the received data are different from the at least one sensor of the plurality of data provider devices associated with the second portion of the received data.

4. The apparatus of claim 1, the memory storing instructions, which when executed by the processor cause the processor to train the data processing model based in part on the received data, to generate a further trained data processing model.

5. The apparatus of claim 4, the memory storing instructions, which when executed by the processor cause the processor to:
update a version of the data processing model based on the further trained data processing model;
store the updated version of the data processing model to a model database;
receive additional data from the plurality of data provider devices;
identify a first portion of the received additional data as additional prediction data;
identify a second portion, different than the first portion, of the received additional data as additional response data;
generate additional inferred response data based in part on the updated version of the data processing model and the additional prediction data;
add metadata to the received additional data including an indication of the updated version of the data processing model; and
store either the additional prediction data or the received additional data to the memory storage location based in part on a comparison between the inferred additional response data, the additional response data, and the error threshold.

6. The apparatus of claim 1, the memory storing instructions, which when executed by the processor cause the processor to:
determine a difference between the response data and the inferred response data;
determine whether the difference is less than, or less than or equal to the error threshold; and
store the prediction data to the memory storage location based on a determination that the difference is less than, or less than or equal to the error threshold.

7. The apparatus of claim 6, the memory storing instructions, which when executed by the processor cause the processor to store the received data to the memory storage location based on a determination that the difference is not less than, or not less than or equal to the error threshold.

8. The apparatus of claim 1, the memory storing instructions, which when executed by the processor cause the processor to send an information element comprising indications of either the prediction data or the received data to a cloud computing device or an edge computing device, wherein the cloud computing device or the edge computing device is to store the prediction data or the received data to the memory storage location.

9. The apparatus of claim 1, the memory storing instructions, which when executed by the processor cause the processor to:
retrieve the prediction data from the memory storage location; and
generate the inferred response data based in part on the prediction data and the data processing model to retrieve the response data.

10. A non-transitory computer-readable storage medium, comprising instructions that when executed by a computing device, cause the computing device to:
receive data from a plurality of data provider devices;
identify a first portion of the received data as prediction data;
identify a second portion, different than the first portion, of the received data as response data;
generate inferred response data based in part on a data processing model and the prediction data;
store either the prediction data or the received data to a memory storage location based in part on a comparison between the inferred response data, the response data, and an error threshold.

11. The non-transitory computer-readable storage medium of claim 10, comprising instructions that when executed by the computing device, cause the computing device to execute the data processing model with the prediction data as input to generate the inferred response data.

12. The non-transitory computer-readable storage medium of claim 10, each of the plurality of data provider devices comprising at least one sensor, the received data comprising indications of signals received from the at least one sensor of the plurality of data provider devices, the medium comprising instructions that when executed by the computing device, cause the computing device to:
identify the first portion of the received data based in part on the at least one sensor of the plurality of data provider devices associated with the first portion of the received data; and
identify the second portion of the received data based in part on the at least one sensor of the plurality of data provider devices associated with the second portion of the received data, wherein the at least one sensor of the plurality of data provider devices associated with the first portion of the received data are different from the at least one sensor of the plurality of data provider devices associated with the second portion of the received data.

13. The non-transitory computer-readable storage medium of claim 10, comprising instructions that when executed by the computing device, cause the computing device to train the data processing model based in part on the received data, to generate a further trained data processing model.

14. The non-transitory computer-readable storage medium of claim 13, comprising instructions that when executed by the computing device, cause the computing device to:
update a version of the data processing model based on the further trained data processing model;
store the updated version of the data processing model to a model database;
receive additional data from the plurality of data provider devices;
identify a first portion of the received additional data as additional prediction data;
identify a second portion, different than the first portion, of the received additional data as additional response data;
generate additional inferred response data based in part on the updated version of the data processing model and the additional prediction data;
add metadata to the received additional data including an indication of the updated version of the data processing model; and
store either the additional prediction data or the received additional data to the memory storage location based in part on a comparison between the inferred additional response data, the additional response data, and the error threshold.

15. The non-transitory computer-readable storage medium of claim 10, comprising instructions that when executed by the computing device, cause the computing device to:
determine a difference between the response data and the inferred response data;
determine whether the difference is less than, or less than or equal to the error threshold; and
store the prediction data to the memory storage location based on a determination that the difference is less than, or less than or equal to the error threshold.

16. The non-transitory computer-readable storage medium of claim 15, comprising instructions that when executed by the computing device, cause the computing device to store the received data to the memory storage location based on a determination that the difference is not less than, or not less than or equal to the error threshold.

17. The non-transitory computer-readable storage medium of claim 10, comprising instructions that when executed by the computing device, cause the computing device to send an information element comprising indications of either the prediction data or the received data to a cloud computing device or an edge computing device, wherein the cloud computing device or the edge computing device is to store the prediction data or the received data to the memory storage location.

18. The non-transitory computer-readable storage medium of claim 10, comprising instructions that when executed by the computing device, cause the computing device to:
retrieve the prediction data from the memory storage location;
generate the inferred response data based in part on the prediction data and the data processing model to retrieve the response data.

19. A system comprising:
a plurality of data provider devices, each of the plurality of data provider devices comprising:
at least one sensor;
an interface; and
circuitry coupled to the at least one sensor and the interface, the circuitry to:
receive signals from the at least one sensor; and
send, via the interface, indications of the signals to a source processing device; and
the source processing device, comprising:
a processor; and
memory storing instructions, which when executed by the processor cause the processor to:
receive data from the plurality of data provider devices, the data comprising indications of the signals received from the at least one sensor of the plurality of data service providers;
identify a first portion of the received data as prediction data;
identify a second portion, different than the first portion, of the received data as response data;
generate inferred response data based in part on a data processing model and the prediction data; and
store either the prediction data or the received data to a memory storage location based in part on a comparison between the inferred response data, the response data, and an error threshold.

20. The system of claim 19, the memory storing instructions, which when executed by the processor cause the processor to execute the data processing model with the prediction data as input to generate the inferred response data.

21. The system of claim 19, the memory storing instructions, which when executed by the processor cause the processor to:
identify the first portion of the received data based in part on the at least one sensor of the plurality of data provider devices associated with the first portion of the received data; and
identify the second portion of the received data based in part on the at least one sensor of the plurality of data provider devices associated with the second portion of the received data, wherein the at least one sensor of the plurality of data provider devices associated with the first portion of the received data are different from the at least one sensor of the plurality of data provider devices associated with the second portion of the received data.

22. The system of claim 19, the memory storing instructions, which when executed by the processor cause the processor to:
train the data processing model based in part on the received data, to generate a further trained data processing model;
update a version of the data processing model based on the further trained data processing model;
store the updated version of the data processing model to a model database;
receive additional data from the plurality of data provider devices;
identify a first portion of the received additional data as additional prediction data;
identify a second portion, different than the first portion, of the received additional data as additional response data;
generate additional inferred response data based in part on the updated version of the data processing model and the additional prediction data;
add metadata to the received additional data including an indication of the updated version of the data processing model; and
store either the additional prediction data or the received additional data to the memory storage location based in part on a comparison between the inferred additional response data, the additional response data, and the error threshold.

23. The system of claim 19, the memory storing instructions, which when executed by the processor cause the processor to:
determine a difference between the response data and the inferred response data;
determine whether the difference is less than, or less than or equal to the error threshold; and
store the prediction data to the memory storage location based on a determination that the difference is less than, or less than or equal to the error threshold; or
store the received data to the memory storage location based on a determination that the difference is not less than, or not less than or equal to the error threshold.

24. The system of claim 19, the memory storing instructions, which when executed by the processor cause the processor to send an information element comprising indications of either the prediction data or the received data to a cloud computing device or an edge computing device, wherein the cloud computing device or the edge computing device is to store the prediction data or the received data to the memory storage location.

25. The system of claim 19, the memory storing instructions, which when executed by the processor cause the processor to:
retrieve the prediction data from the memory storage location;
generate the inferred response data based in part on the prediction data and the data processing model to retrieve the response data.
